(19) United States
(12) Patent Application Publication
(10) Pub. No.: US 2026/0331968 A1
(43) Pub. Date: Oct. 22, 2026

(54) PERMANENTLY-EXCITED DYNAMOELECTRIC MACHINE, METHOD FOR SIMULATION, COMPUTER SYSTEM, AND COMPUTER PROGRAM PRODUCT

(71) Applicant: SIEMENS AKTIENGESELLSCHAFT, München (DE)

(72) Inventors: Rolf Vollmer, München (DE); Jörg Buschbeck, München (DE)

(21) Appl. No.: 19/112,261

(22) PCT Filed: Aug. 15, 2023
(86) PCT No.: PCT/EP2023/072434

§ 371 Date: Mar. 16, 2025

(30) Foreign Application Priority Data
Sep. 16, 2022 (EP) 22196141

(51) Int. Cl. H02K 1/02; B22F 3/14; B22F 3/16; B22F 3/17; B22F 3/24; B22F 9/00; B22F 9/04; C22C 38/00; H01F 1/047; H02K 1/276; H02K 21/16

(52) U.S. Cl. CPC H02K 1/02; B22F 3/14; B22F 3/16; B22F 3/17; B22F 3/24; B22F 9/008; B22F 9/04; C22C 38/002; C22C 38/005; H01F 1/047; H02K 1/276; H02K 21/16; B22F 2003/248; B22F 2301/355; B22F 2998/10; B22F 2999/00; C22C 2202/02

(57) ABSTRACT

The invention relates to a permanently-excited dynamoelectric machine (PDM) with a stator (STT) and a rotor (RTR) mounted rotatably about a longitudinal axis (X), wherein the stator (STT) has a winding system (WND), wherein permanent magnets (PMG) are arranged on the rotor (RTR), wherein the magnetic material of the permanent magnets (PMG) has a preferred direction (PFD) for the magnetisation, so that paths through the permanent magnet (PMG) can be defined in the direction of the local preferred direction (PFD) in each case, wherein a magnet dimension (MTH) in the preferred direction (PFD) associated with a point on a pole face (PAR) is defined as the path length from this point to a corresponding point on the other pole face along the preferred direction (PFD) through the permanent magnet (PMG), wherein a gap (RGP) is formed between the rotor (RTR) and the stator (STT), wherein the winding system (WND) is designed and arranged such that it interacts electromagnetically with the permanent magnets (PMG) of the rotor (RTR) via the gap (RGP). In order to improve the dynamics while saving on rare magnetic materials, it is proposed that the permanent magnets (PMG) are designed as CeFeB-based magnets, wherein the permanent magnets extending at least in portions along the longitudinal axis (X) are designed and arranged in such a way that the permanent magnets (PMG) each have a north pole and a south pole on the side facing the gap (RGP) and the magnet dimension (MTH) in the preferred direction (PFD), starting from the centre of gravity of the north pole, is between 1/10 and ⅓ of the rotor diameter there.

This application is the National Stage of International Application No. PCT/EP2023/072434, filed Aug. 15, 2023, which claims the benefit of European Patent Application No. EP 22196141.0, filed Sep. 16, 2022. The entire contents of these documents are hereby incorporated herein by reference.

### BACKGROUND

The present embodiments relate to a permanently excited dynamoelectric machine.

A permanently excited dynamoelectric machine is known from US 2004/150283 A1. The permanently excited dynamoelectric machine includes a stator and a rotor, a winding system, and permanent magnets on the rotor. The permanent magnets on the rotor have a north pole and a south pole on the side facing the air gap.

A permanently excited dynamoelectric machine of the type cited in the introduction is already known from WO 2006/064589 A1.

It is already known from DE 10 2012 211960 A1 to design CeFeB-based permanent magnets. This is likewise disclosed in the publication by SIEMENS AG: “Besonders feinkristalline, nachhaltige Permanentmagnete für Motor- und Generatoranwendungen” (“Particularly fine crystalline sustainable permanent magnets for motor and generator applications”), PRIOR ART PUBLISHING GMBH, MANFRED-VON-RICHTHOFEN-STR. 9, 12101 BERLIN GERMANY, Vol. Prior Art Journal 2022 #12, 15 Jun. 2022 (2022-06-15), pages 41-43, XP007024723.

Electric machines having a rotor with permanent magnets, each of which has a north pole and a south pole on the side facing the gap, are already known from JP 5 860654 B2.

Background knowledge about electric machines having a rotor with permanent magnets may be found in JP 2018 038162 A.

In relevant permanently excited dynamoelectric machines or PM motors, the dynamic characteristics are affected by different influencing factors. Limiting effects in addition to the intrinsic polar mass moment of inertia also include the thermally permissible torque, the electrical time constant, the torque limit due to the motor voltage, and the saturation behavior of the magnetic circuit.

The resulting dynamics are generally a construction tradeoff between low magnet volume and material costs. A dynamic behavior of a motor may be achieved through the use of expensive neodymium iron boron magnets (e.g., NdFeB magnets) that are characterized by a low volume.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, starting from the problems and shortcomings of the prior art, a more cost-effective solution for achieving high dynamic behavior is provided.

In the context of the present embodiments, a magnetic anisotropy describes the fact that magnetic materials may have a preferred direction or preferred plane for the magnetization. A measure for the magnetic anisotropy is the magnetic anisotropy energy (i.e., the work that is required in order to rotate the magnetization out of the preferred direction).

According to the present embodiments, the magnetic remanence (e.g., remanence for short) describes the remaining magnetism that is retained by the permanent magnet following removal of an external magnetic field. In the present disclosure, the remanence accurately describes the magnetism remaining when the permanent magnet was exposed to the saturation flux density.

In the terminology of the present embodiments, the magnetic coercivity denotes the magnetic field strength necessary to completely and permanently demagnetize a ferromagnetic substance previously charged up to the saturation flux density so that the resulting total flux or the local flux density is equal to zero. This field strength is generally designated by the abbreviation jHc.

The present embodiments achieve the addressed object by a combination of the use of CeFeB magnets and a special motor construction.

Specifically, according to the present embodiments, the permanent magnets are configured as CeFeB-based magnets, where the permanent magnets extending at least in sections along the longitudinal axis are configured and arranged such that the individual permanent magnets each have a north pole and a south pole on the side facing the gap and the magnet dimension in the preferred direction, starting from the center of gravity of the north pole, is between 1/10 and ⅓ of the rotor diameter there.

An embodiment provides that the rotor is, for example, 45 mm (+/−10%) in diameter in a region of the magnets including the magnets. This results in the magnet dimension in the preferred direction, starting from the center of gravity of the north pole, being between 4.5 mm and 15 mm. Given a diameter of 90 mm (e.g., +/−10%), the resulting magnet thickness, starting from the center of gravity of the north pole, is between 9 mm and 30 mm.

Misch metal, including Cer misch metal, is a metal alloy composed of rare earth metals. Standard qualities typically consist of min. 98% rare earth metals, 1% iron, and 0.8% magnesium. Since separating the rare earth metals is an extremely complex process due to their great chemical similarity, it is more cost effective to use a misch metal.

Iron misch metal alloys having an iron fraction of 15% to 50% are referred to as Cer iron or by the trade name Auermetall.

The percentage distribution of rare earth metals in traditional misch metal results directly from that of the starting mineral monazite: it contains approximately 45% to 52% cerium, 20% to 27% lanthanum, 15% to 18% neodymium, 3% to 5% praseodymium, 1% to 3% samarium, terbium and yttrium, plus traces of other rare earth metals.

A development of the present embodiments provides that, with the exception of technically unavoidable impurities, the permanent magnets possess a material composition according to the pattern of a basic composition CeFeB+X+Z. In this case, the material contains between 20% w/w and 35% w/w cerium. In terms of content, each of the elements Nd, Pr, La, Y, Dy, Tb, Gd, Ho accounts for less than 10% w/w, and in total less than <15% w/w. It also applies in this case that the total formed from the components Nd, Pr, La, Y, Dy, Tb, Gd, Ho, and Ce amounts to between 25% w/w and 35% w/w. The component Z accounts for up to 6% w/w by content and stands in this case for at least one element from Al, Co, Cu, Ga, Si, Ge, each accounting for max. 3% w/w. The element boron makes up between 0.85% w/w and 1.1% w/w of the content. The element Fe accounts for between 59% w/w and 75% w/w or forms the remainder of the composition.

According to a development of the present embodiments, two variants for manufacturing the magnets are provided.

A first variant, fabrication via the “powder metallurgical route” or the “sintered magnet,” provides the following method acts: melting an alloy; decanting and solidifying the melt to form a solid body (e.g., as Cast rip or strip cast), so that the solid body is produced in the form of a ribbon; granulating the solid body to a particle size of <10 μm (e.g., <5 μm); aligning the particles in a magnetic field in order to set a preferred direction or a magnetic anisotropy; pressing (e.g., so that shells or lenses exhibiting magnetic anisotropy are formed); sintering; and heat treatment.

A second variant, fabrication via the “rapid solidification route” or the “hot-pressed magnet,” provides the following method acts: melting an alloy; rapid solidification by melt spinning to form a solid body; hot-pressing the solid body; and hot reshaping of the green compact in order to set the preferred direction.

The rapid solidification may be accomplished by a swiftly rotating copper wheel (e.g., “melt spinning”) that quickly dissipates the heat.

Optionally, an aftertreatment process may be performed in each of the two variants via grain boundary diffusion using at least one element from the group Nd, Pr, La, Y, Dy, Tb, Gd, Ho, Bo, or alloys thereof.

Hot pressing, or hot isostatic pressing (HIP), is a development of manufacturing technology in which powder and other solid materials as appropriate are simultaneously hot-pressed and sintered. Hot pressing involves a shaping process based on pressing and the sintering of ceramic material in one processing operation.

The hot reshaping of the green compact in the second variant is a reshaping step above the recrystallization temperature of the metals involved. The solidification taking place during the reshaping may be accompanied by relaxation and desolidification processes being performed during and after the reshaping step. The processes entail, for example, rolling or pressing of the workpiece.

The winding system of the machine is at least partly embedded in a material that forms a magnetic backiron.

According to a development of the present embodiments, the rotor may be configured as an internal rotor, and the permanent magnets may be radially attached externally on the rotor.

According to another development of the present embodiments, the rotor may be configured as an external rotor, and the permanent magnets may be arranged on the rotor on an internal surface facing the gap.

The advantages of the present embodiments are revealed particularly well when the number of poles of the rotor magnets is less than or equal to sixteen. In one embodiment, the number of poles is less than or equal to eight. This may be demonstrated by simulations.

A development of the present embodiments provides that the permanent magnets possess at least one of the following properties: the remanence lies between 0.7 T and 1.0 T at room temperature; and the magnetic coercivity (jHC) lies between 450 kA/m and −750 kA/m at room temperature.

A development of the present embodiments provides that the machine is configured and the permanent magnets are dimensioned and arranged such that during operation of the machine, the B field amplitude of the fundamental wave in the gap amounts to between 0.7 T and 0.85 T.

Another development of the present embodiments provides that the permanent magnets, which each have a north pole and a south pole on the side facing the gap, have a horseshoe-shaped, trapezoidal, or lens-shaped cross-sectional shape. Designing the permanent magnets in a lens or shell shape provides that the section of the permanent magnet facing away from the gap substantially follows the preferred magnetic direction, irrespective of the number of poles of the rotor. Using the lens shape, a constant cross-section of the permanent magnet is achieved for the field line curve without the need to utilize superfluous magnetic material. This helps to save mass in order to reduce the mass moment of inertia or to improve the dynamics, and to minimize the costs for magnets.

A development of the present embodiments further provides that the magnets are implemented as segmented or combined (e.g., at least partly adhesively bonded together) axially and/or radially and/or in a circumferential direction. Owing to the modularity, this option opens up a good level of flexibility in terms of design and simplifies the manufacturing. Alternatively, the permanent magnets may be implemented in a single piece, at least radially and/or in the circumferential direction, such that improved magnetic properties may be realized and a reduction in joins results in an absence of mechanical weak points.

With the option that provides that the permanent magnets in each case have a north pole and a south pole on the side facing the gap, it is beneficial if each of the permanent magnets is configured and mounted on the rotor such that the magnet lines on the side of the gap enter the rotor at a first circumferential position, are redirected such that they extend tangentially in sections, and the magnet lines exit the rotor at a second circumferential position.

With regard to the magnets, an embodiment of the motor provides that the magnets may be divided into axial segments of 3 mm to 5 mm, and/or the magnet dimension in the preferred direction lies in the center of the pole between 5 mm and 12 mm in the case of shell-shaped magnets and between 10 mm and 25 mm in the case of lens- or horseshoe-shaped (see FIG. 2) magnets.

With regard to the motor construction, an embodiment of the motor further provides that: the number of poles amounts to a maximum of sixteen (e.g., eight); and/or the pitch between the iron teeth of the stator to the rotor amounts to 0.6 mm to 1 mm; and/or the stator sheets may have a sheet thickness of less than 150 μm; and/or the groove slots between the teeth are present in all the sheets.

Owing to the present embodiments and the described developments, a permanently excited dynamoelectric machine exhibiting lower inductance results in each case. This enables rapid current buildup, resulting in a high dynamic response. Further, the voltage limiting characteristic curve is consequently also shifted to high torques, which likewise increases the dynamics of the motor. The chosen air gap induction enables high torques at the thermally permissible stator current. Thus, it is also possible to utilize the high dynamics over a long period of time. The stator current generates a low armature reaction such that the relationship between current and torque is linear up to high torques. From this, there results an improvement in the dynamic response of the motor. The construction according to the present embodiments leads to a motor that increases the productivity of the application machine. This applies, for example, to machine tools, robots, and production machines.

A development provides a computer-implemented method for simulating a machine according to the present embodiments or one of its developments. A computer system including at least one computer configured and prepared for the simulation according to the method may be used for this purpose. The computer or the computer system may be prepared for this purpose by a corresponding computer program product for performing a method according to the present embodiments or one of its developments.

### BRIEF DESCRIPTION OF THE DRAWINGS

FIG. 1 shows a simplified schematic cross-sectional view of a permanently excited dynamoelectric machine;

FIG. 2 shows a simplified schematic cross-sectional view of a first variant of a permanently excited dynamoelectric machine according to the present embodiments;

FIG. 3 shows a schematic view of a first method for manufacturing the permanent magnets;

FIG. 4 shows a schematic view of a second method for manufacturing the permanent magnets; and

FIG. 5 shows a schematic view of a simulation of the operation of a machine according to the present embodiments running on a computer with a computer program product.

### DETAILED DESCRIPTION

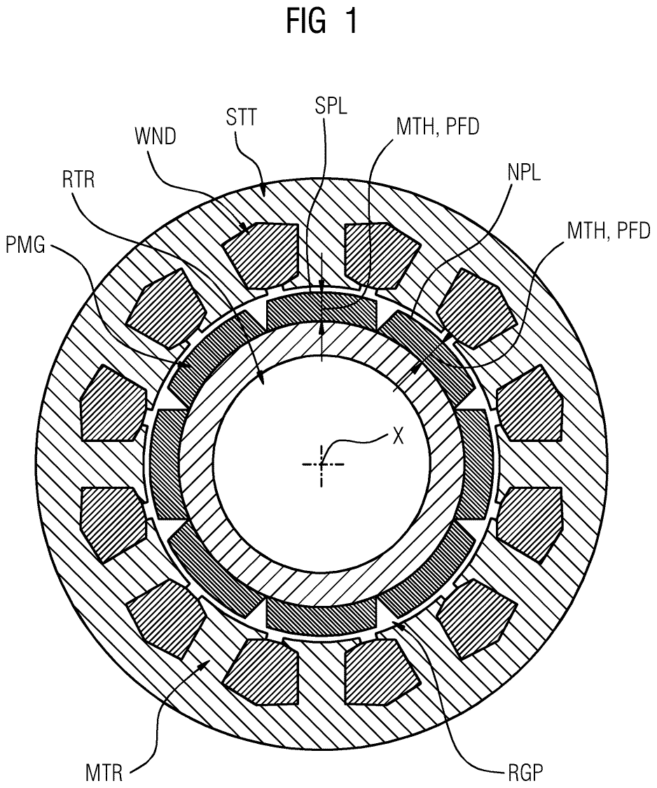

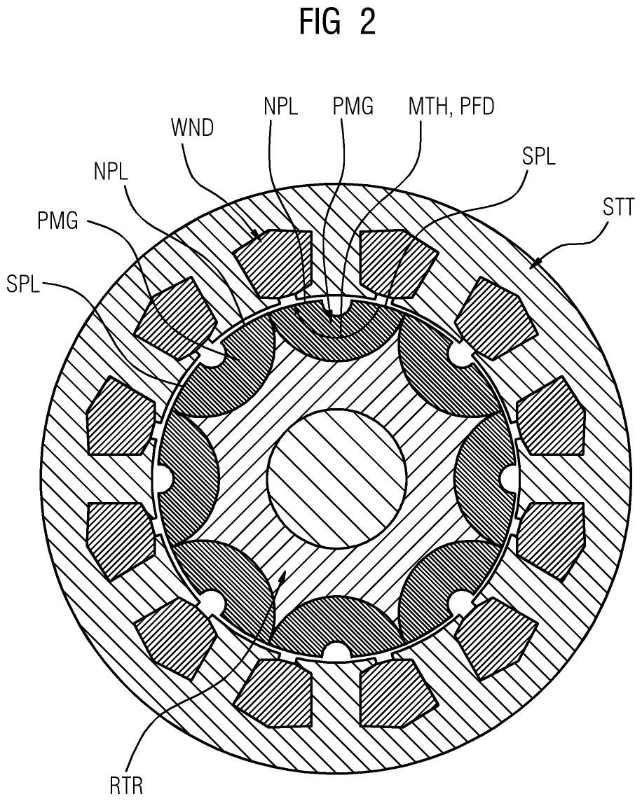

FIGS. 1 and 2 each show a schematic cross-sectional view of a permanently excited dynamoelectric machine PDM including a stator STT and a rotor RTR mounted rotatably about a longitudinal axis X. The stator STT has a winding system WND. Permanent magnets PMG are arranged on the rotor RTR. A gap RGP is formed between the rotor RTR and the stator STT. The winding system WND is configured and arranged such that the winding system WND interacts electromagnetically with the permanent magnets PMG of the rotor RTR via the gap RGP.

The permanent magnets PMG are implemented as CeFeB-based magnets. The permanent magnets PMG extend at least in sections along the longitudinal axis X. In the present case, the permanent magnets PMG have a substantially constant cross-section along their axial extension.

The magnetic material of the permanent magnets PMG has a preferred direction PFD for magnetization such that paths through the permanent magnet PMG may be defined in a direction of the local preferred direction PFD in each case. A magnet thickness MTH associated with a point on a pole face PAR is thereby defined as a path length from this point to a corresponding point on the other pole face along the preferred direction PFD through the permanent magnet PMG.

The winding system WND is embedded in a material MTR that forms a magnetic backiron.

The rotor RTR is implemented as an internal rotor, and the permanent magnets PMG are radially mounted externally on the rotor RTR. Alternatively, the rotor RTR may also be implemented as an external rotor, in which case the permanent magnets PMG would then be arranged on an inner surface facing the gap on the rotor RTR.

In FIG. 1, which shows an example that serves merely to facilitate the understanding of the present embodiments, the permanent magnets PMG enclose the rotor RTR in the manner of a shell with respect to the gap RGP. The magnet thickness MTH in the preferred direction, starting from the center of gravity of the north pole, is between 1/10 and ⅕ of the rotor diameter there.

In FIG. 2, the permanent magnets PMG each have a north pole NPL and a south pole SPL on the side facing the gap RGP. The magnet thickness MTH in the preferred direction, starting from the center of gravity of the north pole NPL, is between 1/10 and ⅓ of a rotor diameter there.

The permanent magnets PMG possess the following properties: the remanence lies between 0.7 T and 1.0 T at room temperature; and the magnetic coercivity jHC lies between 450 kA/m and −750 kA/m at room temperature.

In the embodiment of FIG. 1 and in FIG. 2, the number of poles facing the gap RGP of the permanent magnets PMG on the rotor RTR amounts to eight in each case. Each north pole NPL or south pole SPL disposed there is delimited by the other pole in each case. In FIG. 2, each of the poles is formed jointly by two adjacent permanent magnets that are adjacently disposed in a mirror-inverted arrangement. There are eight permanent magnets PMG on the rotor in each case.

During operation of the machine PDM, the B field amplitude of the fundamental wave in the gap RGP ranges between 0.7 T and 0.85 T.

With the exception of technically unavoidable impurities, the permanent magnets PMG consist of a material composition according to the pattern CeFeB+X+Z, specifically consisting of:

| Component | Percentage by weight |
|---|---|
| Ce | 20% w/w to 35% w/w |
| where X consists of at least one element | <10% w/w in each case |
| from Nd, Pr, La, Y, Dy, Tb, Gd, Ho | and <15% w/w in total |
| where Ce + X | 25% w/w to 35% w/w |
| Z at least one element from Al, Co, Cu, | <3% w/w in each case |
| Ga, Si, Ge | and <6% w/w in total |
| B | 0.85% w/w to 1.1% w/w |
| Fe | Remainder |

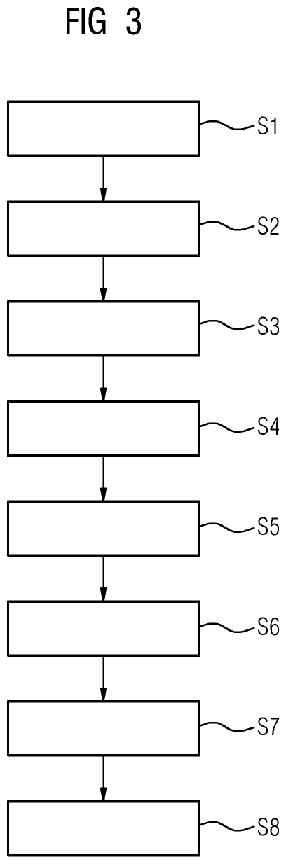

A first method for manufacturing the permanent magnets PMG, shown schematically in FIG. 3, provides the method acts:
S1 melting an alloy;
S2 decanting and solidifying the melt to form a solid body, such as Castrip, so that the solid body is produced in the form of a ribbon;
S3 granulating the solid body to a particle size of <10 μm (e.g., <5 μm;
S4 aligning the particles in a magnetic field in order to set a preferred direction;
S5 pressing;
S6 sintering;
S7 heat treatment;
S8 aftertreatment via grain boundary diffusion using at least one element from the group Nd, Pr, La, Y, Dy, Tb, Gd, Ho, B, or alloys thereof.

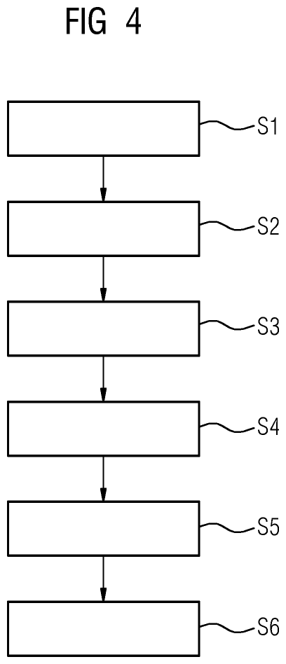

An alternative second method for manufacturing the permanent magnets PMG, shown schematically in FIG. 4, provides the method acts:
a. melting an alloy;
b. rapid solidification by melt spinning to form a solid body;
c. hot-pressing the solid body;
d. hot reshaping of the green compact in order to set the preferred direction;
e. aftertreatment via grain boundary diffusion using at least one element from the group Nd, Pr, La, Y, Dy, Tb, Gd, Ho, B, or alloys thereof.

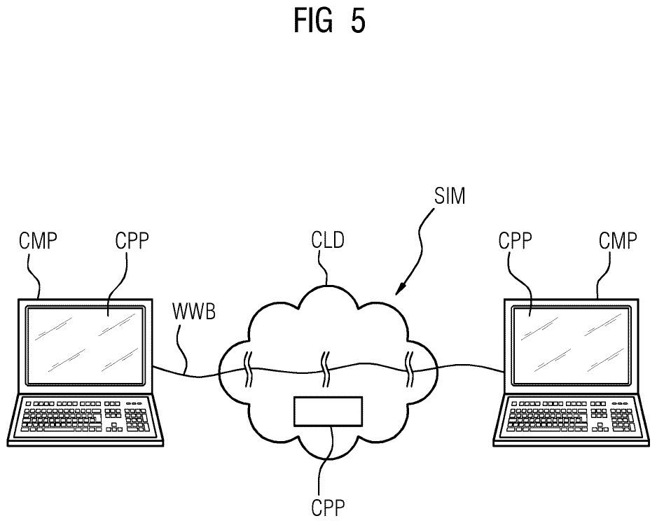

FIG. 5 shows a schematic view of a simulation SIM of a permanently excited dynamoelectric machine PDM according to the present embodiments executing on a computer CMP (e.g., on a number of computers CMP of a network WWB including a cloud CLD). The software installed on the computers CMP is a computer program product CPP that, when executed on at least one computer CMP, enables the user to exert an influence or modify a using interfaces (e.g., using screen and keyboard) and achieve a knowledge gain based on the performed simulation SIM such that, for example, technical design decisions may be supported and verified by the simulation.

Although the invention has been illustrated and described in more detail on the basis of the example embodiments, the invention is not limited by the disclosed examples. Variations hereof may be derived by the person skilled in the art without leaving the scope of protection of the invention as defined by the following claims.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A permanently excited dynamoelectric machine comprising:
a stator and a rotor mounted rotatably about a longitudinal axis, wherein the stator has a winding system; and
permanent magnets arranged on the rotor,
wherein a magnetic material of the permanent magnets has a preferred direction for magnetization, so that paths through the permanent magnets are definable in a direction of a local preferred direction in each case,
wherein a magnet dimension in the local preferred direction associated with a point on a pole face is defined as a path length from the point to a corresponding point on another pole face along the local preferred direction through a permanent magnet of the permanent magnets,
wherein a gap is formed between the rotor and the stator,
wherein the winding system is configured and arranged such that the winding system interacts electromagnetically with the permanent magnets of the rotor via the gap,
wherein the permanent magnets are configured as CeFeB-based magnets,
wherein the permanent magnets extending at least in sections along the longitudinal axis are configured and arranged such that the permanent magnets each have a north pole and a south pole on a side facing the gap and the magnet dimension in the local preferred direction, starting from the center of gravity of the north pole, is between 1/10 and ⅓ of a rotor diameter there.

2. The machine of claim 1, wherein the permanent magnets possess at least one of the following properties:
a remanence lies between 0.7 T and 1.0 T at room temperature; and
a magnetic coercivity lies between −450 kA/m and −850 kA/m at room temperature.

3. The machine of claim 1, wherein during operation of the machine, a B field amplitude of a fundamental wave in the gap is between 0.7 T and 0.85 T.

4. The machine of claim 1, wherein a number of poles of the permanent magnets on the rotor on the side of the gap is less than or equal to sixteen.

5. The machine of claim 1, wherein the permanent magnets, which each have a north pole and a south pole on the side facing the gap, have a horseshoe-shaped, trapezoidal or, lens-shaped cross-sectional form.

6.-12. (canceled)

13. The machine of claim 1, wherein, with the exception of technically unavoidable impurities, the permanent magnets have a material composition according to the pattern CeFeB+X+Z,
wherein the material composition includes 20% w/w to 35% w/w Ce, <10% w/w in each case and <15% w/w in total X, wherein X consists of Nd, Pr, La, Y, Dy, Tb, Gd, Ho, or any combination thereof, <3% w/w in each case and <6% w/w in total Z, wherein Z consists of Al, Co, Cu, Ga, Si, Ge, or any combination thereof, 0.85% w/w to 1.1% w/w B, and the remainder Fe, and
wherein the material composition includes 25% w/w to 35% w/w Ce+X.

14. The machine of claim 1, wherein the permanent magnets are manufactured by:
melting an alloy;
decanting and solidifying the melt to form a solid body, preferably as Castrip, so that the solid body is produced in the form of a ribbon;
granulating the solid body to a particle size of <10 μm, preferably <5 μm;
aligning the particles in a magnetic field such that a preferred direction is set;
pressing;
sintering; and
heat treatment.

15. The machine of claim 1, wherein the permanent magnets are manufactured by:
melting an alloy;
rapid solidification by melt spinning, such that a solid body is formed;
hot-pressing the solid body; and
hot reshaping green compact, such that the preferred direction is set.

16. The machine of claim 14, wherein the permanent magnets are also produced by:
aftertreatment via grain boundary diffusion with at least one element from the group comprising Nd, Pr, La, Y, Dy, Tb, Gd, Ho, B, or alloys thereof.
